(19) United States
(12) Patent Application Publication
(10) Pub. No.: US 2016/0006305 A1
(43) Pub. Date: Jan. 7, 2016

(54) EASILY MOUNTABLE MOTOR ROTOR

(71) Applicant: NEW WIDETECH INDUSTRIES CO., LTD., New Taipei City (TW)

(72) Inventor: Ming-Tsung CHIU, New Taipei City (TW)

(21) Appl. No.: 14/321,067

(22) Filed: Jul. 1, 2014

(51) Int. Cl. H02K 1/28; H02K 1/27

(52) U.S. Cl. CPC H02K 1/28; H02K 1/278

(57) ABSTRACT

An easily mountable motor rotor has multiple magnet holders formed around a periphery of a rotor housing and spaced apart from each other by a gap for a magnet set including multiple magnets to be axially inserted therein. A cover is mounted on a top of the rotor housing to securely position the magnet set. Each of the cover and a bottom of the rotor housing has an opening communicating with a chamber inside the rotor housing and axially penetrated through by a rotor shaft. When the rotor housing is mounted in a stator and the rotor housing drives the rotor shaft to rotate, the magnet holders serve to securely hold the magnets during rotation of the rotor housing. The fixed gap between each adjacent two of the magnet holders prevents the center of gravity from being shifted. Accordingly, the motor rotor can be easily assembled in the stator in a highly efficient manner.

### BACKGROUND OF THE INVENTION

1. Field of the Invention

The present invention relates to a motor rotor, and more particularly to an easily mountable motor rotor.

2. Description of the Related Art

Motors are extensively applied to all sorts of electric appliances in the current market and serve to convert electric power into mechanical energy for driving mechanical parts to rotate, vibrate, move in a straight line or the like. Each conventional motor has a rotor and a stator. The rotor is a rotary part. The stator is a stationary part for providing a magnetic field around the rotor. A gap is maintained between the rotor and the stator for the rotor to be freely rotatable.

With reference to FIG. 6, a conventional motor rotor has a rotor 90, a rotor shaft 91 and multiple magnets 92. The rotor 90 is cylindrical and has a shaft bore centrally formed through the rotor 90. The rotor shaft 92 is mounted through the shaft bore of the rotor 90. The magnets 92 are juxtaposedly mounted around a cylindrical periphery of the rotor 90 and each adjacent two of the magnets 92 are bonded through an adhesive layer 93. The adhesive layer 93 is a sticky binder for magnet bonding, such as propenoic acid ester. The adhesive layer 93 mainly serves to securely affix the magnets 92 on the rotor 90. However, the binder applied to the magnet bonding process is oftentimes unevenly pasted such that the magnets 92 may not be positioned as desired and may not have the same weight. Hence, when the motor rotor is rotating, the center of gravity is shifted and a weight 94 needs to be added to a top or a bottom of the rotor 90 to tackle the issue of the shifted center of gravity of the magnets 92 arising from the inconsistent weights of the magnets 92.

From the foregoing, although the addition of the weight 94 can compensate for the inconsistent weights of the magnets 92 resulted from the uneven application of the binder, the way of adding weight 94 is not an efficient measure in production and cannot guarantee that the produced magnets are consistent in weight. For electric appliances requiring the motor rotor to operate continuously, the motor rotor having the issue of shifted center of gravity upon rotating is danger-prone. Besides, additional time and cost required for mass production of the motor rotor inevitably arise from the magnet-bonding process.

### SUMMARY OF THE INVENTION

An objective of the present invention is to provide an easily mountable motor rotor stably rotated without shifting a center of gravity of the motor rotor during operation, promoting assembly efficiency, and operated with enhanced safety.

To achieve the foregoing objective, the easily mountable motor rotor has a rotor housing, a rotor shaft, a magnet set and a cover.

The rotor housing has a chamber, an open side, a closed side, a shaft bore, an opening and multiple magnet holders.

The chamber is defined inside the rotor housing.

The closed side is opposite to the open side.

The shaft bore is centrally formed through the rotor housing.

The opening is formed through the closed side, corresponds to the shaft bore, and communicates with the chamber.

The magnet holders are annularly formed on and axially protrude from an inner side of the closed side of the rotor housing.

The rotor shaft is mounted through the shaft bore and the opening of the rotor housing.

The magnet set includes multiple magnets. Each magnet is axially held by adjacent two of the magnet holders of the rotor housing.

The cover is mounted on a top of the rotor housing, and has an opening centrally formed through the cover, communicating with the chamber of the rotor housing, and corresponding to the opening of the rotor housing. An inner edge portion of the cover abuts against a top of each magnet.

Given the foregoing structure, when the rotor housing of the motor rotor is rotated with respect to a rotation axis, the rotor housing can be loaded with balanced weights as the magnet holders are formed around the rotor housing and spaced apart from each other by a gap. Additionally, each magnet of the magnet set is axially and firmly inserted into a space defined by adjacent two of the magnet holders and the cover is mounted on the top of the rotor housing to prevent the magnets from coming off due to centrifugal force. Accordingly, the motor rotor can be assembled in the stator in a highly efficient manner.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a motor rotor in accordance with the present invention;

FIG. 2 is a partially exploded perspective view of the motor rotor in FIG. 1;

FIG. 3 is another partially exploded perspective view of the motor rotor in FIG. 1;

FIG. 4 is a partially exploded cross-sectional side view of the motor rotor in FIG. 1;

FIG. 5 is another cross-sectional side view of the motor rotor in FIG. 1; and

FIG. 6 is a perspective view of a conventional motor rotor.

### DETAILED DESCRIPTION OF THE INVENTION

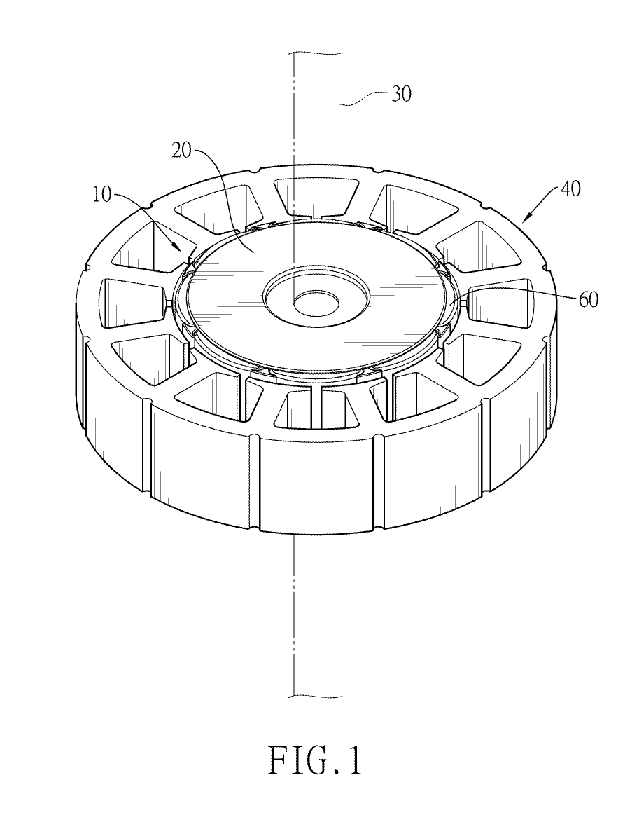

With reference to FIG. 1, an easily mountable motor rotor in accordance with the present invention has a rotor housing 10, a rotor shaft 30, a magnet set, at least one silicon steel plate 50 and a cover 20.

The rotor housing 10 is cylindrical and hollow with an open side and a closed side and has a shaft bore centrally formed through the rotor housing 10. The rotor shaft 30 is mounted through the shaft bore of the rotor housing 10. The magnet set is mounted around a cylindrical periphery of the rotor housing 10. The cover 20 is mounted on a top of the rotor housing 10 for the magnet set to be fastened on the rotor housing 10. For practical application, the rotary housing 10 is mounted through an annular stator 40. A gap is maintained between an inner wall of the stator 40 and the magnet set such that the rotor housing 10 won't rub the stator 40 upon driving the magnet set to rotate.

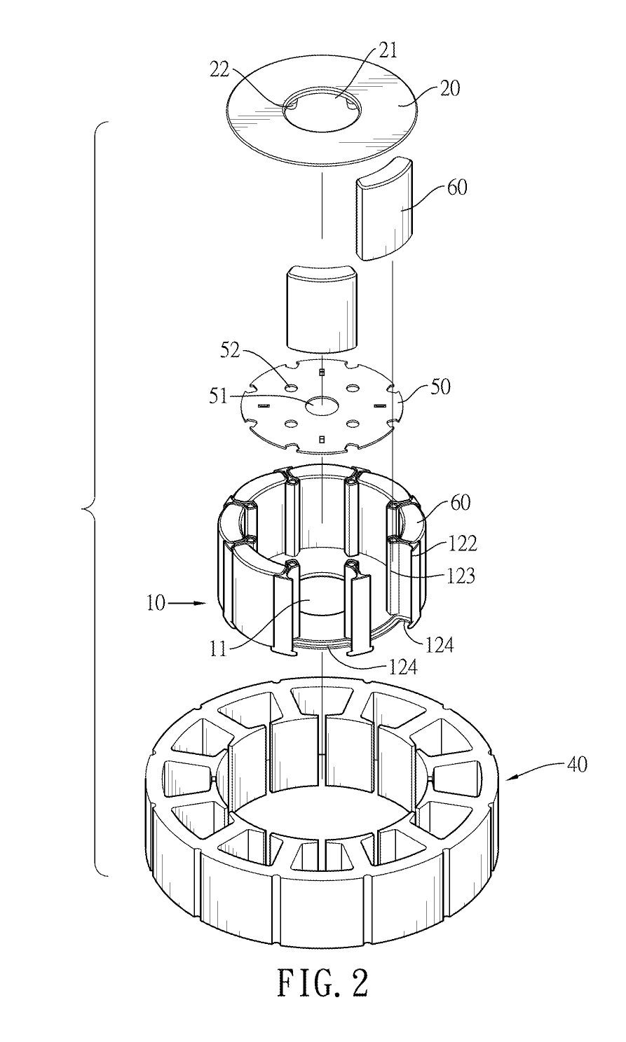

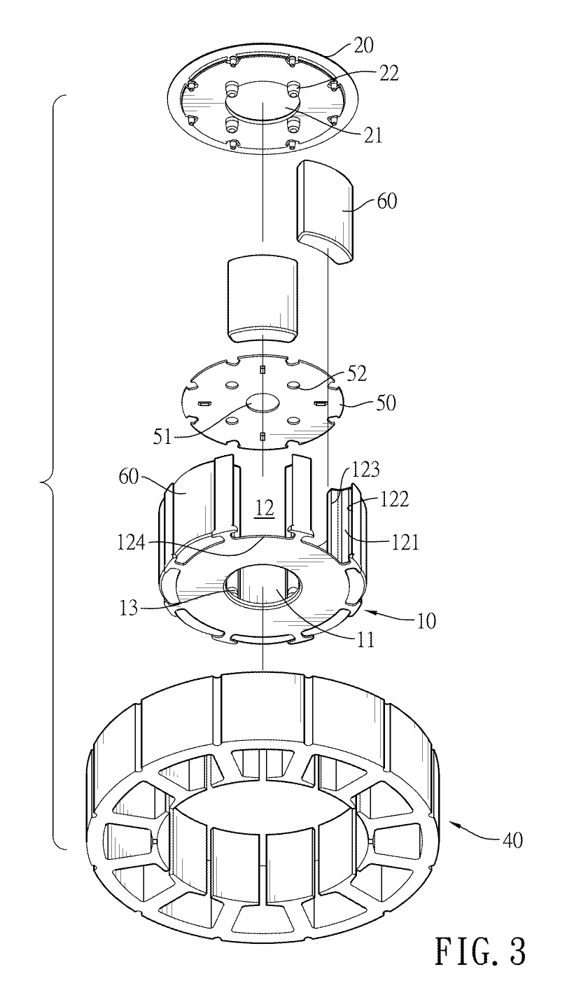

With reference to FIGS. 2 and 3, the rotor housing 10 has an opening 11 and multiple magnet holders 12. The opening 11 is formed through the closed side of the rotor housing 10 opposite to the open side of the rotor housing 10, corresponds to the shaft bore of the rotor housing 10, and communicates with a chamber defined inside the rotor housing 10. The magnet holders 12 are annularly formed on and protrude from an inner side of the closed side of the rotor housing 10 in an axial direction, are annularly arranged, and are spaced apart from each other by a gap. Each one of the at least one silicon steel plate 50 is annular, is mounted inside the chamber of the rotor housing 10, and has a shaft hole 51 and multiple positioning holes 52. The shaft hole 51 is centrally formed through the silicon steel plate 50, aligns with the shaft bore and corresponds to the opening 11 of the rotor housing 10 for the rotor shaft 30 to penetrate through. The positioning holes 52 are formed through the silicon steel plate 50 and are located around the shaft hole 51. The at least one silicon steel plate 50 is made of a magnetic material commonly used in motors.

The magnet set includes multiple magnets 60. Each magnet 60 is arc-shaped, is axially held by adjacent two of the magnet holders 12 of the rotor housing 10, and has an inner wall, an outer wall, two radial sides, a top and a bottom. The radial sides are opposite to each other and radially formed between the inner wall and the outer wall of the magnet 60. A cross-sectional contour in a radial direction of the inner walls of the inserted magnets 60 and the magnet holders 12 matches a contour of a rim of each one of the at least one silicon steel plate 50.

The cover 20 is mounted on the open side of the rotor housing 10, and has an opening 21 and multiple positioning pins 22. The opening 21 is centrally formed through the cover 20, communicates with the chamber of the rotor housing 10, and corresponds to the opening 11 of the rotor housing 10 and the shaft hole 51 of each silicon steel plate 50. The positioning pins 22 are formed on an inner side of the cover 20 to respectively correspond to the positioning holes 52 of the at least one silicon steel plate 50. The rotor housing 10 further has multiple positioning pins 13 formed on the inner side of the closed side of the rotor housing 10 and respectively corresponding to the positioning holes 52 of the at least one silicon steel plate 50. When the at least one silicon steel plate 50 is mounted inside the chamber of the rotor housing 10, the positioning holes 52 of each one of the at least one silicon steel plate 50 are disposed around the respective positioning pins on the cover 20 or on the rotor housing 10 or are disposed between the cover 20 and the rotor housing 10 such that the at least one silicon steel plate 50 can be firmly fixed inside the chamber of the rotor housing 10.

In the present embodiment, each magnet 60 matches a space defined between any adjacent two of the magnet holders 12 in size. Each magnet holder 12 has a middle wall 121, an inner holding portion 122 and an outer holding portion 123. The middle wall 121 has two surfaces being axially parallel to each other. The inner holding portion 122 and the outer holding portion 123 are respectively formed on two axial edge portions of the middle wall 121 for the magnet holder 12 to be I-shaped. When each magnet 60 is inserted into the space between two corresponding magnet holders 12, the two radial sides of the magnet 60 respectively abut against the middle walls 12 of the two corresponding magnet holders 12, the inner wall of the magnet 60 is held by the inner holding portions 122 of the two corresponding magnet holders 12, and the outer wall of the magnet 60 is held by the outer holding portions 123 of the two corresponding magnet holders 12, such that the magnet set can be securely mounted in the rotor housing 10.

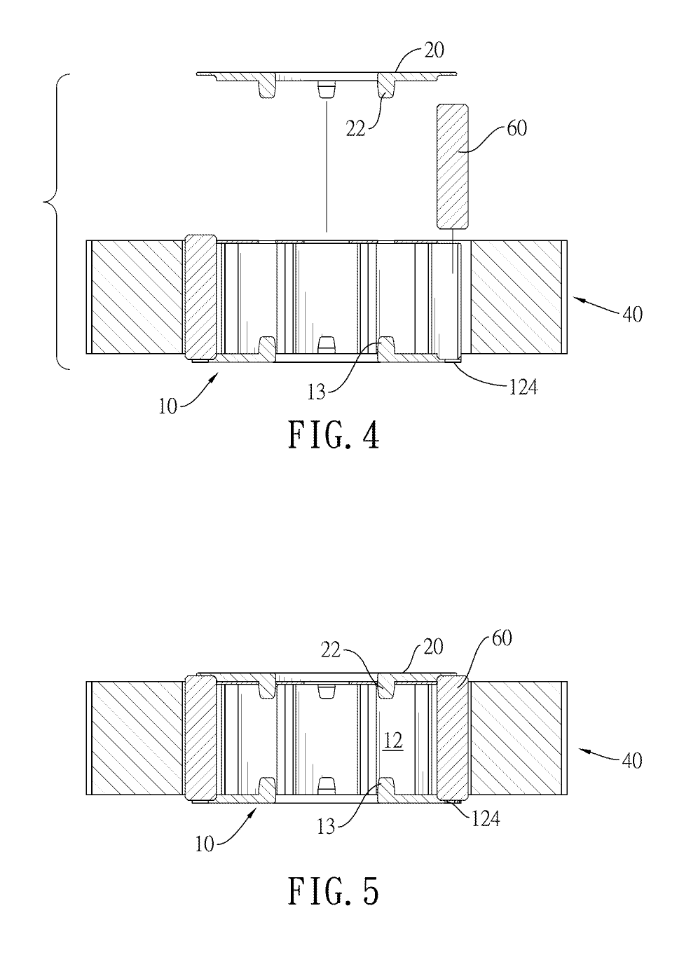

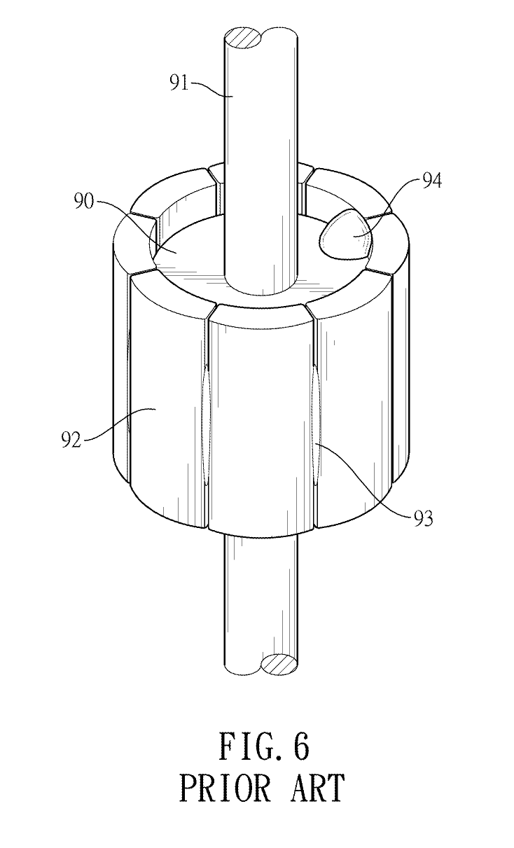

With reference to FIGS. 3 and 4 for further elaborating the assembly of the magnet set and the rotor housing 10, the rotor housing 10 further has an annular flange support 124 annularly formed around an outer perimeter of the bottom of the rotor housing 10 and radially extending into the space between each adjacent two of the magnet holders 12. When each magnet 60 is inserted into the space between two corresponding magnet holders 12, an inner portion of the bottom of the magnet 60 is supported by the annular flange support 124. With reference to FIG. 5, when the cover 20 is mounted on the top of the rotor housing 10, an inner edge portion of the cover 20 abuts against the tops of the magnets 60 such that the top and the bottom of each magnet 60 are held by the inner edge portion of the cover 20 and the annular flange support 124 of the rotor housing 10, the radial sides of the magnet 60 respectively abut against the middle walls of two adjacent magnet holders 12, and the inner wall and the outer wall of the magnet 60 are respectively held by the inner holding portions 122 and the outer holding portions 123 of the two adjacent magnet holders 12.

When the rotor housing 10 is mounted through the stator 40 and is rotated, the magnets 60 mounted around the rotor housing 10 and held by the magnet holders 12 remain firmly fastened. As the magnet holders 12 are orderly arranged and spaced apart from each other by a gap, the rotor housing 10 with the loaded magnets therein can be rotated in a balanced manner without shifting the center of gravity thereof. Accordingly, the motor rotor can be easily mounted and also takes operation safety into account.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An easily mountable motor rotor, comprising:
a rotor housing having:
a chamber defined inside the rotor housing;
an open side;
a closed side being opposite to the open side;
a shaft bore centrally formed through the rotor housing;
an opening formed through the closed side, corresponding to the shaft bore, and communicating with the chamber; and
multiple magnet holders annularly formed on and axially protruding from an inner side of the closed side of the rotor housing;
a rotor shaft mounted through the shaft bore and the opening of the rotor housing;
a magnet set including multiple magnets, wherein each magnet is axially held by adjacent two of the magnet holders of the rotor housing; and
a cover mounted on a top of the rotor housing and having an opening centrally formed through the cover, the opening of the cover communicating with the chamber of the rotor housing and corresponding to the opening of the rotor housing, wherein an inner edge portion of the cover abuts against a top of each magnet.

2. The easily mountable motor rotor as claimed in claim 1, further comprising at least one silicon steel plate mounted inside the chamber of the rotor housing, wherein each one of the at least one silicon steel plate is annular, and has a shaft hole centrally formed through the silicon steel plate and aligning with the shaft bore of the rotor housing, a cross-sectional contour in a radial direction of inner walls of the magnets and the magnet holders matches a contour of a rim of each one of the at least one silicon steel plate, and each magnet matches a space defined between any adjacent two of the magnet holders in size.

3. The easily mountable motor rotor as claimed in claim 1, wherein the rotor housing further has an annular flange support annularly formed around an outer perimeter of a bottom of the rotor housing and radially extending into the space between each adjacent two of the magnet holders, and an inner portion of a bottom of each magnet is supported by the annular flange support.

4. The easily mountable motor rotor as claimed in claim 2, wherein the rotor housing further has an annular flange support annularly formed around an outer perimeter of a bottom of the rotor housing and radially extending into the space between each adjacent two of the magnet holders, and an inner portion of a bottom of each magnet is supported by the annular flange support.

5. The easily mountable motor rotor as claimed in claim 1, wherein
each magnet has
an inner wall;
an outer wall; and
two radial sides being opposite to each other and radially formed between the inner wall and the outer wall;
each magnet holder has
a middle wall having two surfaces axially parallel to each other and two axial edge portions; and
an inner holding portion and an outer holding portion respectively formed on the two axial edge portions of the middle wall for the magnet holder to be I-shaped, wherein when each magnet is inserted into the space between adjacent two of the magnet holders, the two radial sides of the magnet abut against the middle walls of the two magnet holders, the inner wall of the magnet is held by the inner holding portions of the two magnet holders, and the outer wall of the magnet is held by the outer holding portions of the two magnet holders.

6. The easily mountable motor rotor as claimed in claim 2, wherein
each magnet has
an inner wall;
an outer wall; and
two radial sides being opposite to each other and radially formed between the inner wall and the outer wall;
each magnet holder has
a middle wall having two surfaces axially parallel to each other and two axial edge portions; and
an inner holding portion and an outer holding portion respectively formed on the two axial edge portions of the middle wall for the magnet holder to be I-shaped, wherein when each magnet is inserted into the space between adjacent two of the magnet holders, the two radial sides of the magnet abut against the middle walls of the two magnet holders, the inner wall of the magnet is held by the inner holding portions of the two magnet holders, and the outer wall of the magnet is held by the outer holding portions of the two magnet holders.

7. The easily mountable motor rotor as claimed in claim 3, wherein
each magnet has
an inner wall;
an outer wall; and
two radial sides being opposite to each other and radially formed between the inner wall and the outer wall;
each magnet holder has
a middle wall having two surfaces axially parallel to each other and two axial edge portions; and
an inner holding portion and an outer holding portion respectively formed on the two axial edge portions of the middle wall for the magnet holder to be I-shaped, wherein when each magnet is inserted into the space between adjacent two of the magnet holders, the two radial sides of the magnet abut against the middle walls of the two magnet holders, the inner wall of the magnet is held by the inner holding portions of the two magnet holders, and the outer wall of the magnet is held by the outer holding portions of the two magnet holders.

8. The easily mountable motor rotor as claimed in claim 4, wherein
each magnet has
an inner wall;
an outer wall; and
two radial sides being opposite to each other and radially formed between the inner wall and the outer wall;
each magnet holder has
a middle wall having two surfaces axially parallel to each other and two axial edge portions; and
an inner holding portion and an outer holding portion respectively formed on the two axial edge portions of the middle wall for the magnet holder to be I-shaped, wherein when each magnet is inserted into the space between adjacent two of the magnet holders, the two radial sides of the magnet abut against the middle walls of the two magnet holders, the inner wall of the magnet is held by the inner holding portions of the two magnet holders, and the outer wall of the magnet is held by the outer holding portions of the two magnet holders.

9. The easily mountable motor rotor as claimed in claim 5, wherein the top and a bottom of each magnet are held by the inner edge portion of the cover and the annular flange support of the rotor housing.

10. The easily mountable motor rotor as claimed in claim 6, wherein the top and a bottom of each magnet are held by the inner edge portion of the cover and the annular flange support of the rotor housing.

11. The easily mountable motor rotor as claimed in claim 7, wherein the top and a bottom of each magnet are held by the inner edge portion of the cover and the annular flange support of the rotor housing.

12. The easily mountable motor rotor as claimed in claim 8, wherein the top and a bottom of each magnet are held by the inner edge portion of the cover and the annular flange support of the rotor housing.

13. The easily mountable motor rotor as claimed in claim 10, wherein
each one of the at least one silicon steel plate has multiple positioning holes formed through the silicon steel plate;
the cover has multiple positioning pins formed on an inner side of the cover to respectively correspond to the positioning holes of the at least one silicon steel plate; and
the rotor housing has multiple positioning pins formed on the inner side of the closed side of the rotor housing and respectively corresponding to the positioning holes of the at least one silicon steel plate.

14. The easily mountable motor rotor as claimed in claim 12, wherein
each one of the at least one silicon steel plate has multiple positioning holes formed through the silicon steel plate;
the cover has multiple positioning pins formed on an inner side of the cover to respectively correspond to the positioning holes of the at least one silicon steel plate; and
the rotor housing has multiple positioning pins formed on the inner side of the closed side of the rotor housing and respectively corresponding to the positioning holes of the at least one silicon steel plate.
